(19) United States
(12) Patent Application Publication
(10) Pub. No.: US 2006/0185180 A1
(43) Pub. Date: Aug. 24, 2006

(54) Wheel alignment gauge

(76) Inventor: Winston MacKelvie, Knowlton (CA)

Correspondence Address: Winston MacKelvie, Box 1156, Knowlton, J0E 1V0, CA

(21) Appl. No.: 11/063,398

(22) Filed: Feb. 22, 2005

(51) Int. Cl. G01B 5/24

(52) U.S. Cl. 33/203.18

(57) ABSTRACT

The present invention is a wheel alignment gauge for checking the ‘toe’ and ‘camber’ of the wheels. The gauge can be used with the vehicle on the ground. The gauge uses three identical magnet-ended extension rods which are inserted through the vent holes or spokes of the wheels. The rod's inboard ends magnetically attach to the disc brake rotor surface leaving the outboard ends clear of the vehicle's wheel and bodywork. Flat plates rest on the ground and magnetically attach to the outboard ends to create a plane parallel to the rotor and wheel. Laser-ended alignment arms magnetically attach to the plates, are level, and have forward ends that extend beyond the front of the vehicle allowing the lasers to project ate target sheets centered on the lasers. Each arm also has a perpendicular location arm that contacts the front of the wheel (or rotor when the wheels are removed). The laser's dots provide a off-center measurement, which, along with the arm's spacing, one can calculate the trigonometric SINE of the wheel's angle. The gauge can be quickly changed from vertical to horizontal for camber or toe measurements respectively. If adjustment is required, the vehicle is raised on its suspension, the wheels are removed and the gauge re-attached to locate on the rotors to direct alignment adjustments.

### FIELD OF THE INVENTION

A low-cost gauge or jig for checking the wheel alignment of cars and other vehicles while they are on the ground. The gauge uses the disc brake rotor as the reference plane for alignment.

### BACKGROUND OF THE INVENTION

Wheel alignment saves fuel, provides safer steering and braking, and reduces tire wear. Existing wheel alignment machines are large, expensive and require a large dedicated space (bay) and highly qualified operators. There is a need for a reasonably accurate and low priced gauge that small shops and gas/service stations can quickly use to check wheel alignment as a routine service for customers, and to guide wheel alignment after replacing shock absorbers, struts, ball joints, steering-rod-ends and other suspension-steering components.

### SUMMARY OF THE INVENTION

The present invention is a gauge that uses one or more extension rods of equal length that are square ended with magnets. The rods pass through the vent or spoke openings of the vehicle's wheels (front and/or rear) and magnetically attach to- and extend perpendicularly from the disc brake rotor surface. Preferably at least three extension rods are used. A flat metal plate (steel) is attached to the magnetic outer ends of these extension rods to become the planar reference surface clear of the vehicle's bodywork. The plate can rest on the ground.

Alignment arms with outboard lasers are magnetically attached to each plate. The arms have perpendicular locators to contact the front of the tire such that the outer ends of the alignment arms are at situated equally fore and aft. The alignment arms are adjusted horizontally using built-in levels. The set up is such that the outboard lasers beam across the the front of the vehicle onto respective target sheets centered on each laser. Thus if the wheels were in dead straight alignment, the two laser beams would be coincident and would not show on the targets. All other wheel alignment will show laser dots on the targets. The alignment arms may also be attached to the plates vertically locating on the top of the tire to project the laser beams across the top of the vehicle's hood for more accurate camber indication.

If wheel alignment is required, the gauges are removed, the vehicle is jacked up by the suspension arms just enough to allow removal of the wheels. The gauges are then remounted to the exposed brake rotors, the location arms adjusted to contact the rotor's circumference and corrective adjustment carried out until the laser dots on the target indicate correct alignment.

### BRIEF DESCRIPTION OF THE DRAWINGS

FIG. 1A perspective view of a disc brake rotor and plate supported thereon using equal length, double ended magnetic extension rods, and with laser lamps on the metal disc beaming to targets;

FIG. 2 a side view of a wheel showing the extension rods inserted between spokes;

FIG. 3 a front view showing the wheel, brake rotor, extension rods, metal plate, lasers, and reference rulers;

FIG. 4 a perspective view of an extension rod showing an offset end for reaching discs whose diameter smaller than the wheel's vent hole circular placement diameter;

FIG. 5 a top and/or front view of the tool installed on two wheels showing the laser beams being non-coincident indicating an (exaggerated) degree of toe-in for a top view, and, of positive camber in a front view;

FIG. 6 shows the same view with the wheels removed and a clamp used to hold one alignment arm to the rotor;

FIG. 7 shows a side view where the alignment arm is held to the extension rods using a clamping arrangement and an location rod contacts the front of the tire;

FIG. 8 the same embodiment with the wheel removed and a rear location rod contacting the rear of the rotor;

FIG. 9 shows a top view of the same embodiment;

FIG. 10 shows an embodiment where the plate is resting on the ground and the alignment arm is magnetically attached to the plate, a support rod and level allow each side to be positioned identically, and a locating pin in the alignment arm engages a hole in the plate;

FIG. 11 shows the same embodiment used vertically to test wheel camber and showing the location rods contacting the top center of the tire, and showing on one gauge, how a mirror may be used to project the laser beam towards the mechanic adjusting a wheel's alignment;

FIG. 12 shows a front view of the same embodiment;

FIG. 13 shows an embodiment with two linear bearings added;

FIG. 14 shows the same embodiment with a single double motion linear bearing;

FIG. 15 shows an embodiment with a pivoting bearing added;

FIG. 16 shows the measurements needed to calculate the sine of the degree of the wheel's angle;

FIG. 17 shows a simple single rotatable extension rod embodiment with a magnet on one and and a laser on the other which attaches to an exposed brake rotor;

FIG. 18 shows the same embodiment where the rod passes through an opening in the wheel to reach the brake rotor;

FIG. 19 shows an end view of the two alignment arms and how the laser lamps may be offset on the arms so that the beams are clearly visible on the target arm and not obstructed by the laser lamp body or its lens;

FIG. 20 shows and end view of how a magnetically attached carpenter's inclinometer or angle indicator may be used in conjunction with part of the present invention to determine wheel camber angle.

FIG. 21 diagrammatically shows how a common laser distance measuring unit with calculator may be incorporated in one alignment arm to quickly measure the distance between the two alignment arms and compute the wheel angle for this distance and the distance of misalignment of the laser dot on the target with the opposing laser lens at the target's center;

FIG. 22 shows how the laser may be rotatably mounted on the alignment arm with index marks to indicate wheel TOE angle;

FIG. 22 shows how an end portion of the alignment arm may be made rotatable also with index marks to indicate wheel CAMBER angle.

### DETAILED DESCRIPTION OF THE INVENTION

Vehicle wheels are factory aligned (actually misaligned) in the forward plane to have a specific degree of “toe” (misaligned to aim forwardly towards or away from each other) and in the vertical plane to have a specific degree of “camber” (misaligned to aim vertically towards or away from each other).

Checking alignment of wheels using the present gauge is done from the perspective of the wheel's disc brake rotor B, which is necessarily precisely planar with the wheel. In the preferred embodiment shown in FIGS. 10-15, several equal length, square-ended extension rods 1 having magnets la at each end are used. The inboard ends of these rods 1 pass through wheel openings D′ and attach to rotors B. Plate 2 rests on ground G and attaches to the outboard ends of these rods 1. Plate 2 is therefore planar and parallel to rotor B and to wheel A and serves as the reference surface onto which alignment arms 2a are mounted to conduct the wheel alignment check.

Two alignment arms 2a have three mounting magnets 54 at their inboard end that hold arms 2a planar to plates 2. The outboard ends of alignment arms 2a have lasers 3, levels 12, and perpendicular tire location arms 20. The lasers 3 and location arms 20 are spaced identically on each arm 2a. In manufacture, the lasers 3 are adjusted and locked so as to aim perpendicularly dead center into each other's lens when the two arms 2a are parallel. In use, location arms 20 each touch the outer circumference of their respective wheel A. Location arms 21 are used to contact the rear circumference of their respective rotor B after the wheels are removed.

Each arm 2a may have a support 2b which can be set to a same arbitrary height, and/or, to the same height above ground G as hole 53 (or other shaped apertures such as horizontal and vertical slots) in plate 2. Optional locating pin 22 on arm 2a can then engage hole 53 which makes arms 2a level with ground G as indicated by level 12. The pin 22 and hole 53 can be used to best advantage when the workspace has smooth and level ground G.

The laser's beam 4a cross the vehicle towards opposite targets 51 which have as their center the other laser's emitting lens 3a. The measured amount of deviation 11 of the laser dot 10 (i.e., a red dot) from the center of the target (laser lens 3a) indicates that wheel's state of alignment. If the arms are horizontal to check for “toe”, the effective deviation 11 will typically be in front of or behind the target center and will show “toe-out” or toe-in” respectively. If the arms 2a are vertical the effective deviation 11a will typically be below or above the center of the target and will indicate “positive camber” or “negative camber” respectively.

Because the plate 2 is planar with rotor B and wheel A, the alignment arm 2a is also planar therewith and will in fact show both toe and camber when in either the horizontal or vertical position. However the gauge's accuracy is increased when the two checks are made in separate horizontal and vertical positions.

As shown in FIG. 16, measuring deviation 11 (value D) and arm spacing 100 (value S) provides the two values for a ratio (11:100 or D÷S) the resultant of which is the SINE (a number) of the wheel's angle. Published trigonometric tables or a calculator is used to convert the SINE number to the wheel's actual angle.

When it is shown that alignment is required, the vehicle H is jacked up via its suspension arms (so that the wheel's angles are not altered) and the wheels are removed to gain access to their adjustment means (bolts and nuts). With the wheels off, the two gauges locate on the exposed rotors and adjustments made to bring the laser dots 10 into conformity with the vehicle's alignment specifications.

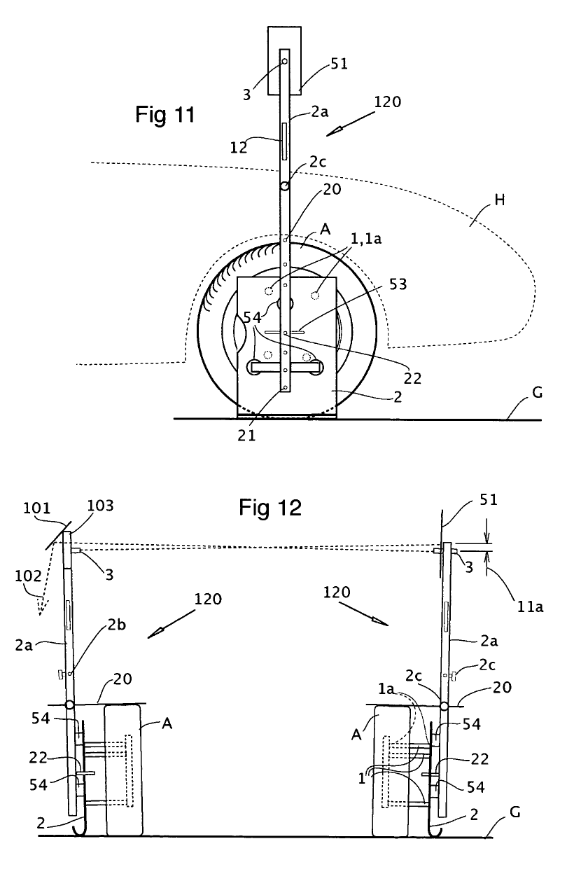

With the wheels off, extension rods 1 may have inboard clamp means 1c to firmly grasp the rotor B during adjustment, and, rear location rod 21 is used to locate against the rear of the rotor B. Several precision-spaced placement holes for location arms 20, 21 may be furnished along the arm 2a as shown in FIG. 10. A cutout in plate 2 (FIG. 11) will allow arm 2a and location rod 21 to reach smaller diameter rotors B.

FIG. 12 on the left side shows how a mirror 101 may be used in conjunction with a transparent end 103 on alignment arm 2a to direct a reflected laser beam 102 towards a mechanic adjusting a wheel's alignment for remote viewing of the alignment progress. The mirror 101 and/or arm 2a may be marked to show the zero point when the arms 2a are parallel. Other markings on the mirror 101 and on targets 51 may be used as a ruler to measure deviation 11a. A two-way mirror with the laser 3 behind it could also be used to effect the same remote viewing (not shown).

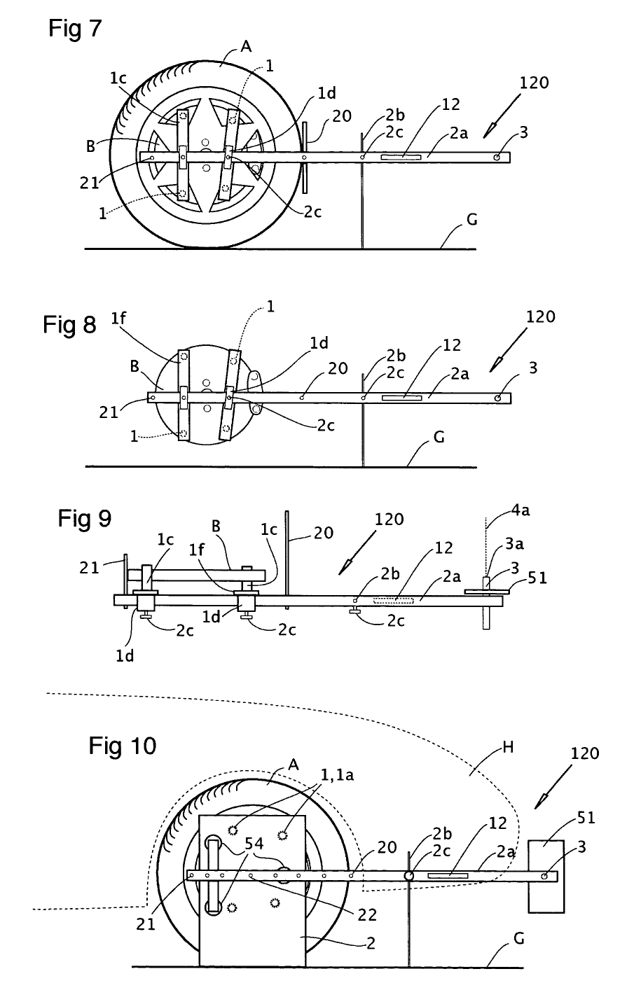

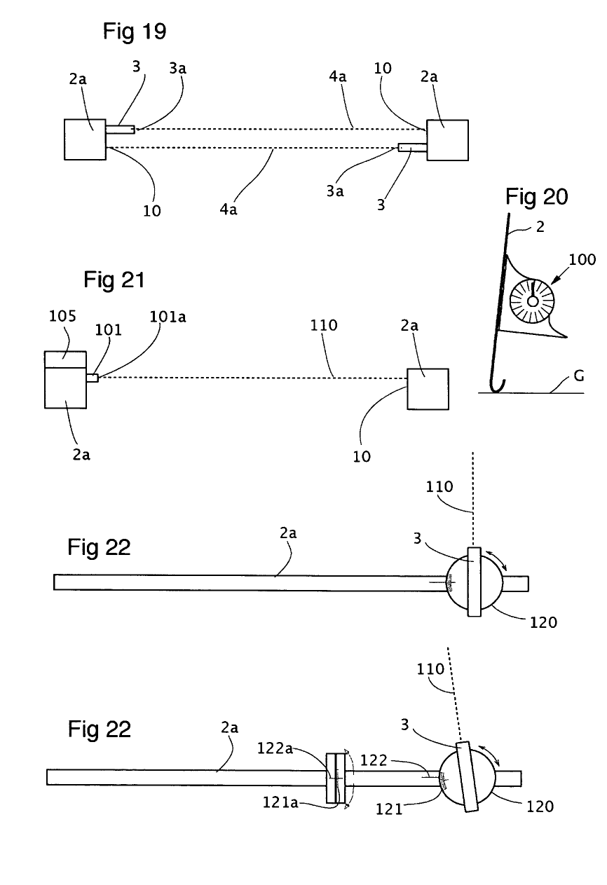

Alternatively the lasers 3 may be located above and below the center line of each respective arm 2a so that the beam 4a is visible on the target arm 2a and not obscured by its laser 3, as shown in FIG. 19. Location arms 20, 21 may have a broad flat shape as shown in FIG. 7 to more accurately locate tangentially to the leading/trailing edge of wheel/rotor periphery. Also an angle plate or post may be placed on the ground in front of the wheel so as to contact the wheel's leading edge and the location arm then brought into contact with it (not shown). Further the location arm 20 may be removably attached so that it can be quickly repositioned to become location arm 21 to contact the rear of the brake rotor. In addition, the alignment arms 2a may be of equal length (distance from outboard laser lens to the inboard end) and long enough so that in the vertical mode, the lower ends of arms 2a each contact the ground G (not shown) serving the same positioning/locating purpose as location arm 20 and eliminating the locator pin 22 and location arm 20.

FIG. 20 shows how a common hardware store magnet inclinometer may be attached to the plate 2 so as to measure wheel camber without the use of arm 2a.

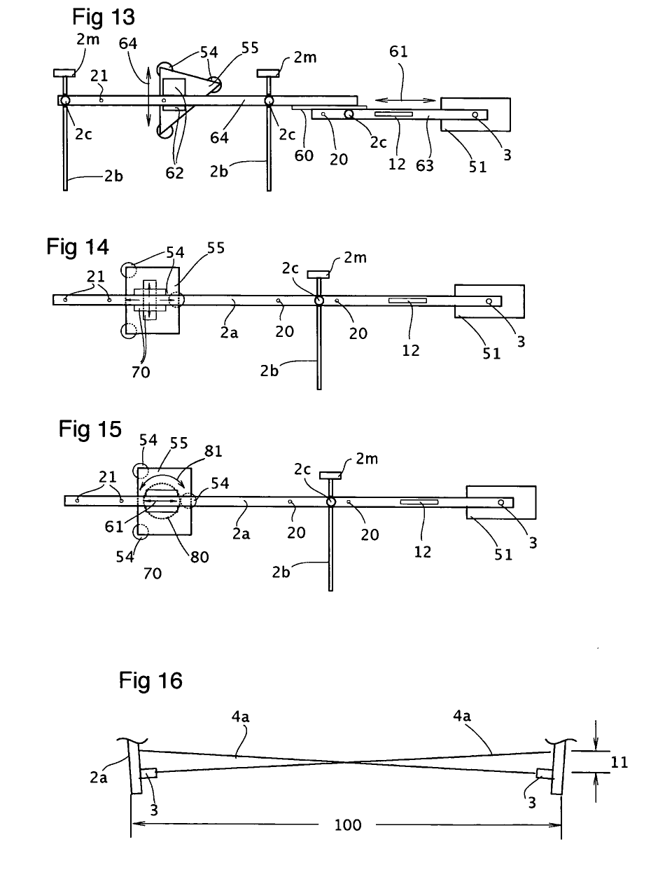

FIG. 21 diagrammatically shows how a common distance measuring unit laser 101 having emitting lens 3a and with associated calculator 105, may be incorporated into one alignment arm to measure the distance between the two alignment arms 2a so as to quickly compute the wheel angle based on the ratio of distance 100 (FIG. 16) and deviation 11. This laser distance measuring may be integrated into existing laser 3. The calculator 105 may also be connected to laser 101 such that the laser-measured distance 100 will be automatically inputted, ready for input of the deviation 11 into the calculator 105. The angle is then displayed by the calculator 105. In greater detail, the calculated result of the ratio deviation 11 divided by distance 100, results in a number which is the SINE of the wheels included angle, such that, from a common table of trigonometric values, the SINE can be looked up and the angle read. In another embodiment exemplified by FIG. 13, the alignment arm 2a of the preferred embodiment is split into two pieces 63, 64 joined together by linear bearing 60. This allows the measuring end 63 (comprising laser 3 and location arm 20) to be quickly adjusted, as shown by arrows 61, to bring location arm 20 to contact the tire, Further, a second linear bearing 62 may be used to separate the attachment end of alignment arm 64 from its carrier 55 (which attaches or is part of plate 2). This bearing 62 allows split alignment arm 63, 64 to move vertically, as shown by arrows 64. A second support 2b may be added and knobs 2m can be used to turn a threaded support 2b to adjust arm 63, 64 level and to adjust its height above ground for different wheel sizes. A variation of this embodiment shown in FIG. 14 also includes keeping the one piece alignment arm 2a and using a double action linear bearing 70 attached to carrier 55 which is magnetically or otherwise fixed to plate 2, This arrangement allows alignment arm 2a to be moved friction free in both required directions 70 quickly and accurately. Thumb screws (not shown) may be added to bearing 70 to lock arm 2a when it is in position.

In yet another embodiment shown in FIG. 15, a rotating bearing 80 between carrier 55 and plate 2 allows carrier 55 and arm to be rotated 81 for leveling or for moving to/from horizontal and vertical positions, while linear bearing 70 provides fore and aft motion 61 of arm 2a to bring location arm 21 to contact wheel A as required.

FIG. 16 shows the measurements 11, 100 (exaggerated for clarity) needed to calculate the degree of toe or of camber of a wheel using the present invention. Lasers 3 project beams that deviate from dead center by deviation 11 which is made equal on each side by turning the steering wheel; right and left alignment arms have a spacing 100. By way of a “toe alignment” example, if deviation 11 measures 1 inch and spacing 100 measures 50 inches then each wheel's “toe” angle is that angle whose SINE is 0.020 (1÷50). From Trigonometric SINE Tables this angle is 1.6 degrees (or 1 degree 10 minutes) per wheel, or 3.2 degrees total toe-in. Table 1 below is a partial reprint taken from the internet of wheel alignment specifications for a Dodge Neon car (http://www.neons.org/neontsb/TSB/02/020694.htm).

TABLE 1
FRONT WHEEL ALIGNMENT

| | |
|---|---|
| TOTAL TOE | 0.30° IN TO 0.10° OUT |
| CAMBER | −0.4° TO +0.4 |

Thus for this particular vehicle using the above example, the wheel “toe” alignment is incorrect there being excessive toe-in. Adjusting the vehicles steering arms (tie rods) until the deviation 11 measures, say, zero inches, would bring this vehicles alignment to within factory specifications. Likewise for camber.

In FIG. 2 a wheel has wheel nuts or studs G and center hub C. Disc brake has rotor B and caliper E attached with bolts F. Disc brake rotor B runs planar with a wheel A since they are both accurately mounted on the same axle (not shown). With the wheels A on the ground, access to the rotors is through openings D′ such as those between spokes D common in alloy wheels or through the round vent openings in plain steel wheels (not shown). In all Figures, extension rods 1 are equal length, are square-ended and their inboard ends contact the brake rotors B. The inboard ends of rods 1 may attach magnetically or by clamp means 1c as in FIGS. 6 and 9.

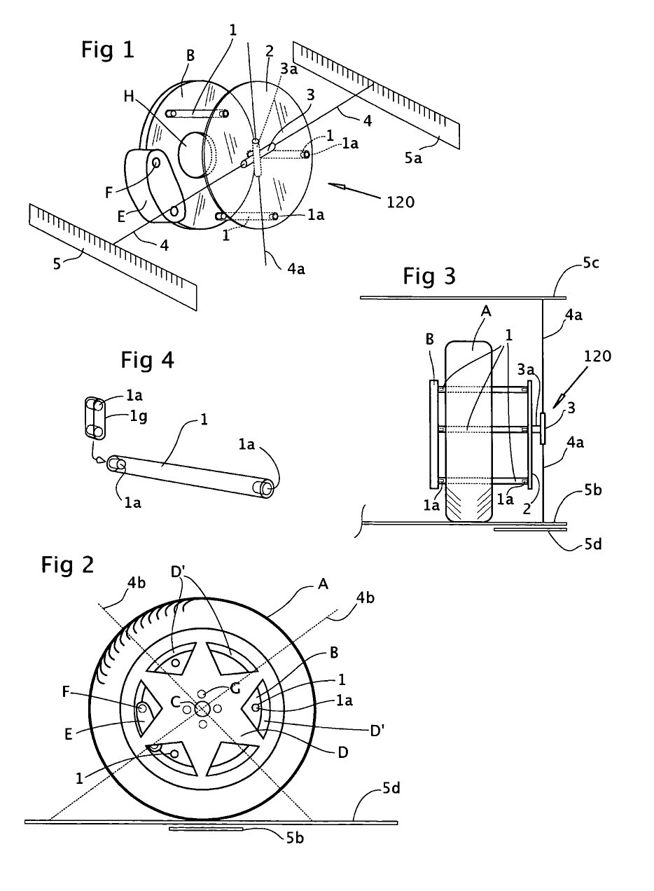

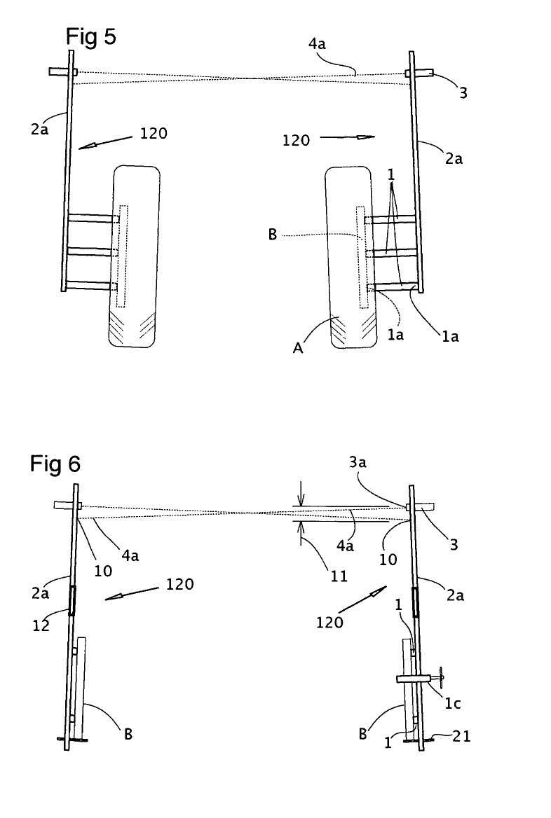

FIG. 1 shows how plate 2 (sheet steel) is held planar to rotor B using at least three extension rods 1. Plate 2 then becomes the surface onto which laser or other sighting or measuring tools can be mounted. Plate 2 may be of different sizes or have suitable cutouts to adapt to larger and smaller vehicle rotor diameters

Extension rods 1 have strong magnets 1a at each end. Where the rotor B is smaller than the circle pattern of the vent holes of a wheel, an offset 1g shown in FIG. 4 can be used on the inboard end of rod 1 so that the magnet 1a on the offset contacts the rotor B. Once the rods 1 and plate 2 are assembled onto the rotors B of the wheels A to be checked for alignment, various types of indicator devices may be attached to plate 2 which is now planar and parallel with the wheel A.

In a simpler embodiment, laser 3 is rotatably attached by magnetic or other means such as a bearing to plate 2 at the center of the plate 2 so as to project a horizontal beam 4, a vertical beam 4a, or a angled beam 4b (as shown in FIGS. 1, 2, 3) toward a target such as a standing horizontal ruler 5a which may be positioned on stands (not shown), or toward floor targets 5d parallel with, and alongside the vehicle, or towards floor target 5b which is perpendicular to and underneath the vehicle, or upwards towards an overhead suspended target 5c.

With each wheel's laser cooperatively aimed, the alignment can be determined by measuring the relative position of the respective laser dots. For example, if the vehicle's factory stated track (wheel spacing) is 60 inches and the lasers are 5 inches beyond the track on each side but the laser beams are 59 inches apart on a target close to the wheel, then a toe-in of 1 inch exists at target distance. If the target is a greater distance from the laser, then the converging or diverging effect of target distance from the laser is calculated according to that distance and the state of the wheel's alignment is thereby determined. The same applies for both toe and camber measurements.

In another embodiment alignment arms 2a are attached to plates 2 magnetically or by other means. In FIGS. 7, 8, 9 the arms 2a are clamped to bars If which in turn are attached to the rods 1. Clamp screw 2c allows arm 2a to move in cage Id while support 2b is set at, or close to, wheel center height and locked with thumb screw 2c thus allowing arm 2a to be leveled (according to level 12) and then clamped to bars If with thumb screws 2c.

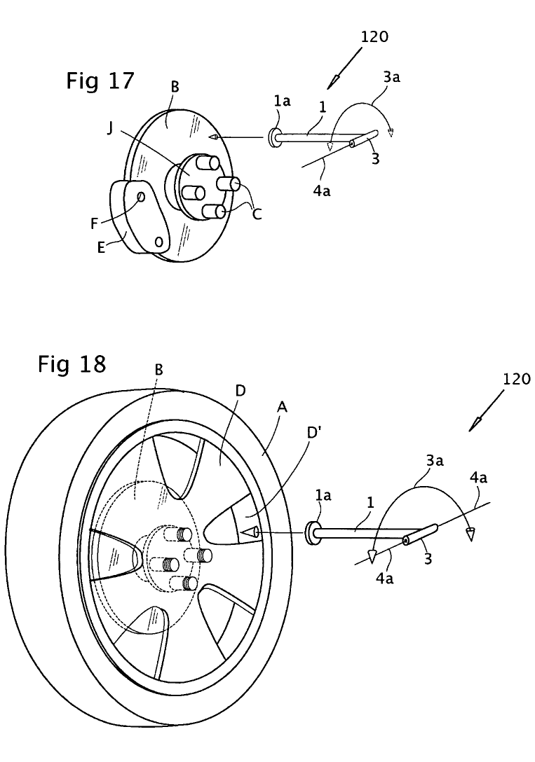

FIG. 17, 18 show the simplest embodiment comprising a single extension rod 1 to be inserted through wheel opening D′ to contact rotor B with magnet 1a on the inboard end and a laser lamp 3 on the outboard end. Either end can be arranged with bearing means to enable the laser 3 to rotate 3a in plane and beam its light 4a towards suitable targets such as 5a, 5b, 5c and 5d in FIGS. 1-3. The larger the diameter of magnet 1a the better, so as to bridge a scored or grooved rotor surface. This embodiment can also have an offset end as shown in FIG. 4. In FIG. 18 the rotor is shown without caliper E or wheel nuts for clarity.

Plate 2 may have ball feet (not shown) to allow easy positioning on ground G and may be weighted after installed to prevent unwanted movement.

Of course all magnet attachments described above could be replaced by other means such as threaded fasteners, suction cups, clips, clamps, stretched rubber cords, mechanical interlocks, and the like.

Alignment arms 2a and their respective plates 2 could be a one piece assembly such that the assembly is attached to extension rods 1 in a horizontal or a vertical mode to gauge the above mentioned wheel/rotor alignment angles.

In another embodiment, the lasers 3 may be mounted on a rotatable degree dial 120 with angular divisions 121 and a zero index mark 122 on alignment arm 2a. These degree dial's show zero angle when lasers 3 project their beam 110 perpendicularly and on to each other's lens 3a. When the gauge 120 is attached to the vehicle and a horizontal laser dot deviation 11 is present on targets 51, the degree dial 120 is rotated to bring the dot back horizontally to center (i.e., lens 3a) and the vehicle wheel's angle read from the dial markings. The alignment arm could also have its end section holding the laser 3 rotatable for centering the dot in the vertical plane this end section could also have angular markings and an index mark to read off the vertical angle, or camber, of the wheel when the end is rotated to bring the dot to its vertical center.

It follows from the aforementioned disclosure that other surfaces that are planar to the wheel may be used with the present invention to check alignment, surfaces such as: areas on the wheel itself; the wheel's drive flange or hub; the wheel mounting studs or holes, the drum brake drum, these providing alignment reference with the wheels still on the vehicle, and, providing working clearance from the vehicle's bodywork for unobstructed operation.

I claim:

1. A wheel alignment gauge for a vehicle, said vehicle having pairs of front and rear wheels and pairs of front and rear brake systems associated respectively therewith, said pairs of said wheels and said brakes in some required degree of parallel, side-by-side relationship, each said wheels and/or said brakes having at least one flat surface thereon parallel with said wheel;
said gauge comprising;
at least one extension rod having parallel inboard and outboard and where said inboard end has means of attachment to said at least one flat surface,
said outboard end adapted to hold means of indication of the said degree of parallel relationship between said pairs of front and/or rear wheels.

2. The gauge of claim 1 where said means of attachment of said inboard end is magnetic.

3. The gauge of claim 1 where said at least one flat surface is a disc portion of a disc brake brakes.
